(19) United States
(12) Patent Application Publication
(10) Pub. No.: US 2007/0246088 A1
(43) Pub. Date: Oct. 25, 2007

(54) Automatic, touchless, exterior rollover vehicle wash machine and system

(76) Inventor: Donald J. Rennie, Midlothian, VA (US)

Correspondence Address: WILLIAMS MULLEN, 222 CENTRAL PARK AVENUE, SUITE 1700, VIRGINIA BEACH, VA, 23462, US

(21) Appl. No.: 11/789,736

(22) Filed: Apr. 25, 2007

Related U.S. Application Data
(60) Provisional application No. 60/794,679, filed on Apr. 25, 2006.

(51) Int. Cl. B08B 3/00; B08B 3/12

(52) U.S. Cl. 134/123; 134/172; 134/199

(57) ABSTRACT

The present invention provides an improved exterior rollover vehicle washing machine and/or cleaning system including an external frame, a gantry having no internal propulsion, a motor, a drive line/pulley system, at least two washer arm assemblies, a water supply line and a chemical supply line. In one embodiment, the motor has belt and pulley members to move the gantry back and forth along a frame track. The washer arms can move horizontally alongside the vehicle from vehicle front to vehicle back, as well as horizontally toward and away from the vehicle. The washer arms can further be pivotally mounted to the gantry so as to move within a 90 degree range such that the water supply line and/or chemical supply line can rotate from approximately 45 degrees to one side of the normal line directed at the vehicle to 45 degrees on the other side of the normal line directed at the vehicle.

### REFERENCE TO RELATED APPLICATIONS

This application claims the benefit under 35 U.S.C. §119(e) of U.S. provisional patent application No. 60/794,679, filed Apr. 25, 2006 and entitled “Automatic, Touch-Free, Exterior Rollover Vehicle Wash Machine and System,” the disclosure of which is hereby incorporated by reference in its entirety.

### FIELD OF THE INVENTION

The present invention relates to car wash machines and more particularly relates to an automatic, touchless, exterior rollover car wash machine.

### BACKGROUND OF THE INVENTION

Car wash machines are known in various forms and various degrees of automation. The most basic form of car wash is the self-service open bay car wash. These types of washes can include a pressure sprayer and optionally a foaming brush or similar device connected to a large central pump. The sprayer can be integrated with a box or selection system that allows the user to pick a spray option. For example, the user may select “pre-soak,” “soap,” “water rinse” and/or “wax.” Many such systems are coin-operated and allow the user to spend as much time (and as many coins) as they desire on a particular spray selection.

Another form of car wash is called an exterior rollover wash, which allows the user to drive his or her vehicle into the wash bay up to a stopping point. Once stopped, different washing elements are applied as car-wash equipment moves over and around the vehicle on a track.

Still another form of car wash is the “exterior only” car wash, which operates using a conveyor belt to pull one or more front tires through the bay. The car is pulled past several pieces of equipment in assembly line type fashion, with each piece of equipment having a specific purpose (e.g., soap, rinse, dry, etc.). A “full service” car wash is often considered to be an “exterior only” car wash with additional personal services, such as hand drying, wheel cleaning, interior vacuuming and the like. Exterior only and full service car wash machines are expensive to build and maintain.

The above types of car washes can come in “touchless” or “cloth friction” form. Cloth friction washes employ soft cloths that contact and move about the surface of the vehicle, and these cloths can create scratches or other undesirable surface permutations on a vehicle exterior. On the other hand, “touchless” car washes operate just as they sound, where no brushes, applicators or other non-liquid material contacts the vehicle in any manner during washing and cleaning.

### SUMMARY OF THE PRESENT INVENTION

The present invention provides an automatic, touch-free, exterior rollover vehicle wash machine that is inexpensive to assemble, operate and maintain, and that provides a superior cleaning system over previously known wash machines and systems.

### BRIEF DESCRIPTION OF DRAWINGS

FIG. 1 is a front left perspective schematic view of a car wash machine in accordance with one embodiment of the present invention.

FIG. 2 is a front schematic view of the machine of FIG. 1, showing movement of washer arm assemblies in phantom in accordance with one aspect of the present invention.

FIG. 3 is a top schematic view of the car wash machine in accordance with one embodiment of the present invention.

FIG. 4 is a cutaway perspective view of a washer arm assembly in accordance with one aspect of the present invention.

### DETAILED DESCRIPTION OF INVENTION EMBODIMENTS

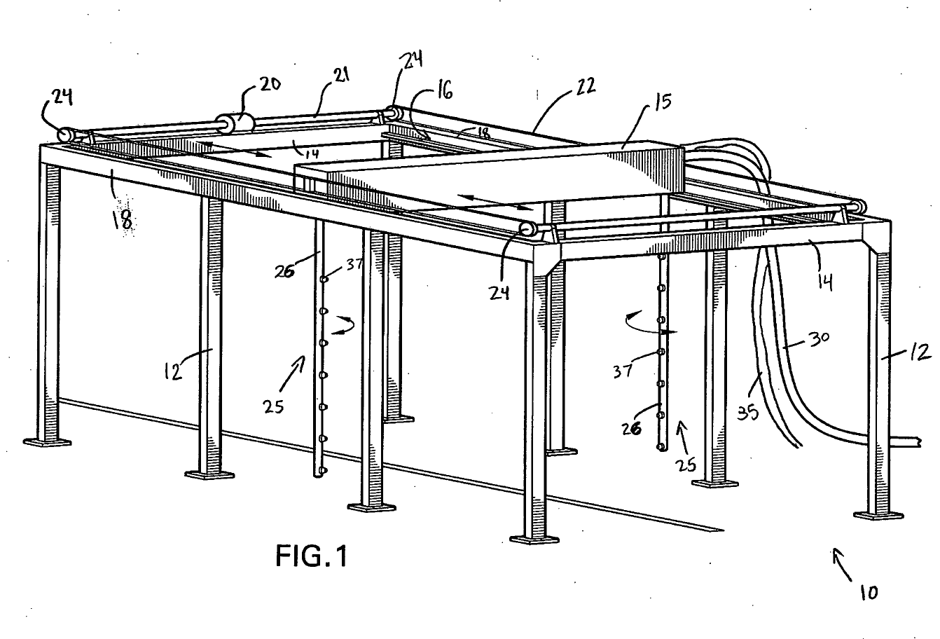

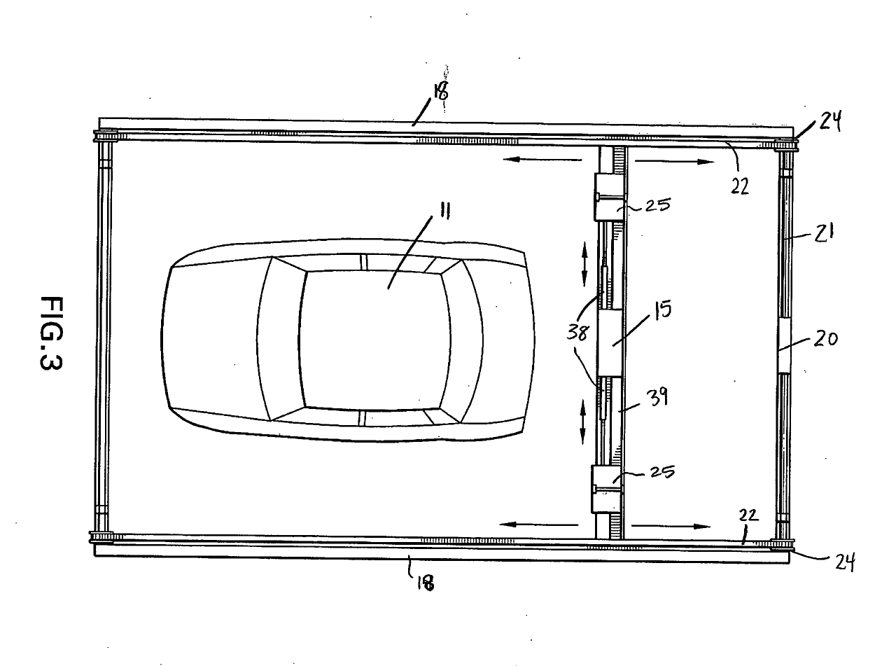

As shown in FIGS. 1 through 4, the machine and system of the present invention include a framework 10 into which a vehicle 11 to be washed can enter. The framework includes substantially vertical support members 12 and substantially horizontal support members 14. In one embodiment of the present invention, the parts of the framework are made of extruded aluminum, with each part made so as to mate properly and securely with the other parts of the framework. As a result, the present invention eliminates in-house metal working, welding and other ad hoc building and mounting methods.

In the preferred embodiment, a vehicle 11 to be washed enters the bay (open space) created inside the framework and proceeds to a certain stopping point, where the vehicle is typically placed in “park” and the engine typically turned off. The vehicle does not move during operation of the car wash machine of the present invention.

A motorless cart and/or gantry 15 is movingly mounted to the top portion of the framework using wheels secured to the outside edges of the gantry, for example, such that the gantry slides within tracks 16 on the inner surfaces of parallel upper frame members 18 of the framework. In one embodiment, the gantry 15 is moved by a 0.5-1.0 Hp external motor 20 mounted at one end of the top portion of the framework, using drive line members 22 and pullies 24 secured on either side of the motor 20. The motor can operate using 24V, in one embodiment of the invention, thereby drawing lower power than is typically required on other car wash systems with internal drives. The drive line members 22 can be a belt, chain, cable or other similar line capable of providing tension and durability to the system of the present invention. The motor include a built-in gearbox to provide power and speed to the drive line member/pulley system, and a motor shaft 21 is operatively engaged with the gearbox and pulleys to mechanically couple the motor and the pulleys. The belts, chains and/or cables are secured to the gantry to allow the gantry to travel up and down the tracks 11. Unlike previous car wash machines, there is no propulsion provided on or within the gantry itself. As such, the present invention provides a motor-less gantry that eliminates slipping, track heat and expensive internal drive systems. The present invention is also more easily assembled and repaired as a result.

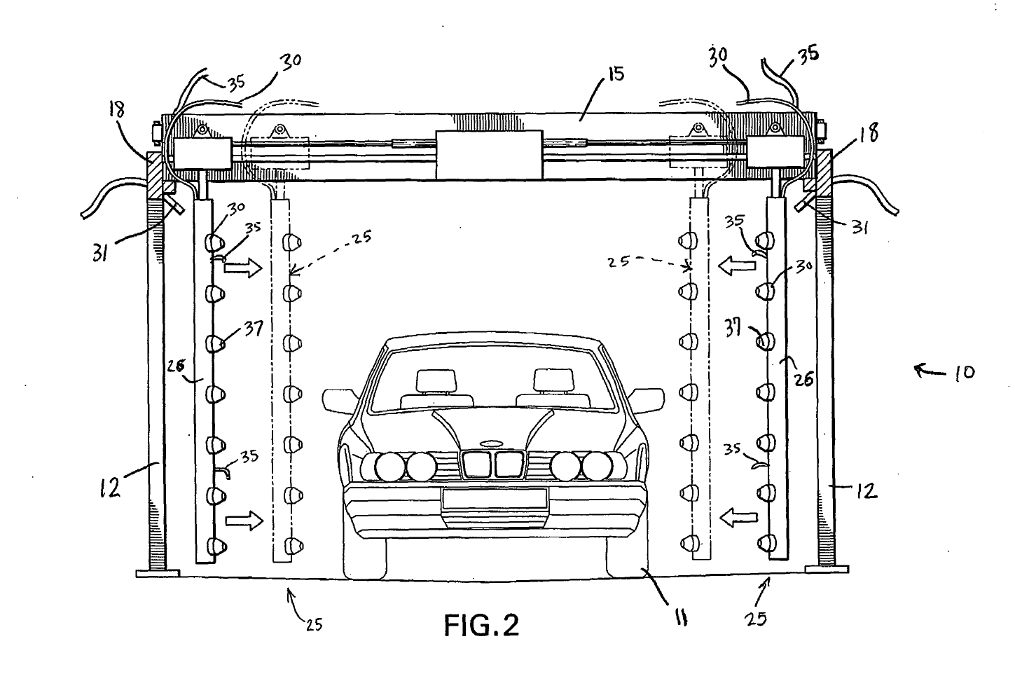

Washer arm assemblies 25 including washer arms 26 are secured to the gantry and move with the gantry as it is powered back and forth around the vehicle. Water 30 and chemical 35 delivery systems are secured to the washer arm assemblies and the gantry to assist in washing and cleaning the vehicle. In one embodiment of the present invention, the water and chemical supplies are provided from outside sources, as will be understood to those of skill in the art. Nozzles 37 are provided at the ends of the delivery systems to assist in targeted release of the water and/or chemicals. In one embodiment, the water delivery system is under high-pressure and the chemical delivery system is under low pressure. It will be appreciated that the chemical delivery system can accommodate all types of applications, including pre-soaks, soaps, foams, waxes and rinses. As shown in FIG. 2, in one embodiment of the invention, special foam release nozzles 31 can also be provided at the upper portion of the frame and aimed downwardly toward the vehicle being cleaned.

In one embodiment of the invention, the water and chemical delivery systems are applied at approximately forty-five degree (45°) angles to the surface of the vehicle, as opposed to the ninety degree (90°) angles typical of previous car wash machines. The substantially forty-five degree angle ensures better coverage of the chemicals into various nooks and crannies alongside the vehicle. Also, high pressure water applied at roughly forty-five degrees helps to lift dirt from the vehicle surface and pushes all water and dirt in one direction to assist with vehicle cleaning, as in power washing a surface, for example. This angling of the delivery systems and nozzles can be seen, for example, in FIGS. 1 and 2. If the nozzles were angled at ninety degrees, then the nozzles from the left arm would be pointing directly toward the nozzles from the right arm.

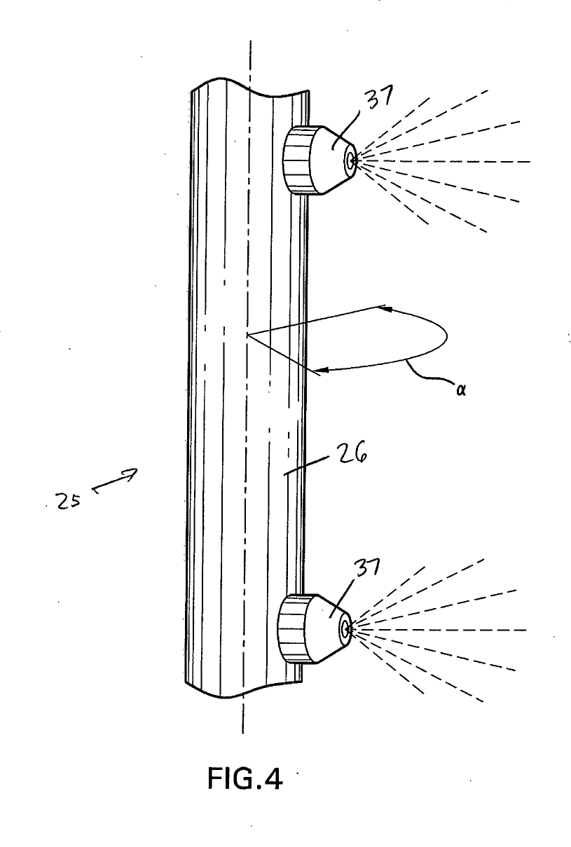

In one embodiment of the invention as shown in FIGS. 1 and 4, the side arms 26 can rotate such that the water and chemical delivery systems can face the vehicle at approximately forty-five degrees in both directions of gantry travel. This range of motion of a total of approximately 90 degrees is indicated by the angle alpha (α) in FIG. 4. For example, when the gantry is located approximately at the front of a vehicle, the motor can propel the gantry towards the rear of the vehicle, in which case the water and chemical delivery system nozzles will be faced towards the rear of the vehicle at an approximately forty-five degree angle. When the gantry reaches the rear of the vehicle, the arms can be rotated back approximately ninety degrees toward the front of the vehicle, such that the delivery systems and nozzles are now pointed back towards the front of the vehicle at approximately a forty-five degree angle. In one embodiment of the invention, all arm motions are driven pneumatically, such as by piston/cylinder arrangements mounted to the gantry, and the arms are capable of moving inwardly towards the vehicle and outwardly away from the vehicle via a slide bearing 38 secured within a gantry/cross-beam frame element 39. This movement in and out assists the present invention in better cleaning the front end and back end of the vehicle being cleaned. The inward movement is depicted, for example, by the arrows in FIG. 2 and the phantom lines of the washer assemblies 25.

It will be appreciated that the combination of propulsion mechanisms and arm rotation capabilities of the present invention facilitate greater efficiency and collision avoidance during operation. For example, the present invention can operate such that the washer arm assemblies and/or the washer arms move toward and away from the vehicle up to a limit of approximately two to three feet, as opposed to moving inward to the point of contacting each other as in other car wash systems. This can be effected by limiting the extent of track on the gantry/cross-beam frame element to restrict the distance over which the slide bearing can move. Because the arms are rotatable to approximately forty-five degrees in either direction, the arms need not travel as far in order to thoroughly clean the front and back ends of the vehicle. This saves time and power during operation, and further avoids collisions with vehicles that may be moved too soon during operation of the car wash, for example. Thus, the present invention can effectively restrict the movement of the arms inward and outward such that they cannot contact one another.

In one embodiment of the invention, the washer arm assemblies can be simultaneously moved up or back alongside a vehicle while being moved inwardly towards or outwardly away from the vehicle. In another embodiment of the invention, the entire unit can be packaged and sold as a kit.

It should be understood that the foregoing description and examples are only illustrative of the present invention; the optimum dimensional relationships for the parts of the invention, including variations in size, materials, shape, form, function and the manner of operation, assembly and use, are deemed readily apparent to one skilled in the art, and all equivalent relationships to those illustrated in the drawings and described in the specification are intended to be encompassed by the present invention. Thus, various alternatives and modifications can be devised by those skilled in the art without departing from the invention. Accordingly, the present invention is intended to embrace all such alternatives, modifications, and variances that fall within the scope of the appended claims.

What is claimed and desired to be secured by Letters Patent is:

1. A vehicle washing machine, comprising:
an external frame having at least two upper frame members formed so as to define a track on the inner surface thereof;
a motor-less gantry secured between opposite frame members so as to be capable of moving along the track, wherein the gantry has no internal propulsion mechanism;
a motor mounted to the frame;
pulley and drive line means secured to the motor and to the gantry such that operation of the motor can power the gantry along the track;
at least two washer arm assemblies secured to the gantry so as to depend downwardly from the gantry;
at least one water supply line secured to at least one of the washer arm assemblies; and
at least one chemical supply line secured to at least one of the washer arm assemblies.

2. The machine of claim 1 wherein the water supply line can be pointed at approximately forty-five degrees away from the normal line to a vehicle being washed.

3. The machine of claim 1 wherein the chemical supply line can be pointed at approximately forty-five degrees away from the normal line to a vehicle being washed.

4. The machine of claim 1 wherein the washer arm assemblies each include a washer arm that can be pivoted so as to move within an approximately ninety degree range such that the water supply line or chemical supply line can rotate from approximately forty-five degrees to one side of the normal line directed at the vehicle to approximately forty-five degrees on the other side of the normal line directed at the vehicle.

5. The machine of claim 1 wherein the washer arm assemblies each include a washer arm that can be moved inwardly toward a vehicle being washed and outwardly away from the vehicle being washed using pneumatic pressure, wherein the washer arm assemblies are mounted on a slide bearing secured to a cross-beam frame element secured to the upper frame members.

6. The machine of claim 1 wherein the washer arm assemblies can move substantially horizontally alongside the vehicle from vehicle front to vehicle back, as well as substantially horizontally toward and away from the vehicle.

7. The machine of claim 1 wherein the water delivery system is under high-pressure and the chemical delivery system is under low pressure.

8. The machine of claim 1 further including one or more foam release nozzles secured to the gantry.

9. The machine of claim 1 wherein the frame is formed of extruded aluminum.

10. A vehicle cleaning system, comprising:
an external frame having a track maintained on the inner surface of at least two upper members;
a motor-less gantry having no internal propulsion secured between opposite frame members so as to be capable of moving up and back along the track;
at least two washer arm assemblies secured to the gantry so as to depend downwardly from the gantry; and
at least one water supply line secured to at least one of the washer arm assemblies, wherein the water supply line has a release nozzle pointed at approximately forty-five degrees away from the normal line to a vehicle being washed.

11. The system of claim 10 wherein the washer arm assemblies can move substantially horizontally alongside the vehicle from vehicle front to vehicle back, as well as substantially horizontally toward and away from the vehicle.

12. The system of claim 10 wherein the washer arm assemblies can be pivoted so as to move within a approximately ninety degree range from approximately forty-five degrees to one side of the normal line directed at the vehicle to approximately forty-five degrees on the other side of the normal line directed at the vehicle.

13. A vehicle cleaning system, comprising:
an external frame having a track maintained on the inner surface of at least two upper members;
a motor-less gantry having no internal propulsion secured between the frame members so as to be capable of moving up and back along the track; and
at least two washer arm assemblies secured to the gantry so as to depend downwardly from the gantry, each of the washer arm assemblies including a washer arm that can be pivoted so as to move within a ninety degree range such that the water supply line and/or chemical supply line can rotate from approximately forty-five degrees to one side of the normal line directed at the vehicle to forty-five degrees on the other side of the normal line directed at the vehicle.

14. The system of claim 13 further including at least one water supply line secured to at least one of the washer arms, wherein the water supply line has a release nozzle pointed at approximately forty-five degrees away from the normal line to a vehicle being washed.

15. A vehicle cleaning system, comprising:
an external frame having a track maintained on the inner surface of at least two upper members;
a motor-less gantry having no internal propulsion secured between opposite frame members so as to be capable of moving up and back along the track;
a motor mounted to the frame and having pulley and belt means secured to the gantry to move the gantry up and back along the track; and
at least two washer arm assemblies secured to the gantry so as to depend downwardly from the gantry, wherein the washer arm assemblies can move substantially horizontally alongside the vehicle from vehicle front to vehicle back, as well as substantially horizontally toward and away from the vehicle.

16. A method for providing a car wash machine, comprising the steps of:
providing an external frame having a track maintained on the inner surface of at least two upper members;
providing a motor-less gantry having no internal propulsion secured between the frame members so as to be capable of moving up and back along the track;
providing at least two washer arm assemblies secured to the gantry so as to depend downwardly from the gantry; and
providing at least one water supply line secured to at least one of the washer arm assemblies, wherein the water supply line has a release nozzle pointed at approximately forty-five degrees away from the normal line to a vehicle being washed.

17. The method of claim 16 wherein the washer arm assemblies each include a washer arm that can move substantially horizontally alongside the vehicle from vehicle front to vehicle back, as well as substantially horizontally toward and away from the vehicle.

18. The method of claim 16 wherein the washer arm assemblies each include a washer arm that can be pivoted so as to move within an approximately ninety degree range such that the water supply line or chemical supply line can rotate from approximately forty-five degrees to one side of the normal line directed at the vehicle to approximately forty-five degrees on the other side of the normal line directed at the vehicle.

19. The method of claim 16 wherein the step of providing the frame includes extruding individual frame elements from aluminum.

20. The method of claim 17 wherein the horizontal movement of the washer arms is restricted such that the arms cannot move to a point where the arms contact one another.
